(19) United States
(12) Patent Application Publication
(10) Pub. No.: US 2007/0099069 A1
(43) Pub. Date: May 3, 2007

(54) Catalyst for a fuel cell, a method for preparing the same, and a membrane-electrode assembly for a fuel cell including the same

(76) Inventors: Myoung-Ki Min, Suwon-si (KR); Chan-Hee Park, Suwon-si (KR); Young-Gil Park, Suwon-si (KR); Chan Kwak, Suwon-si (KR); Alexey AlexandrovichSerov, Suwon-si (KR); Si-Hyun Lee, Suwon-si (KR)

Correspondence Address: Robert E. Bushnell, Suite 300, 1522 K Street, N.W., Washington, DC, 20005, US

(21) Appl. No.: 11/591,501

(22) Filed: Nov. 2, 2006

(30) Foreign Application Priority Data
Nov. 2, 2005 (KR) 10-2005-0104202

(51) Int. Cl. H01M 4/92; H01M 4/96; H01M 4/88; B01J 21/18; B01J 23/42

(52) U.S. Cl. 429/44; 502/101; 502/180; 502/339

(57) ABSTRACT

The present invention relates to a catalyst for a fuel cell, a method of preparing the same, and a membrane-electrode assembly for a fuel cell including the same. The catalyst includes a platinum (Pt) nanowire and a carbon-based material supporting the Pt nanowire.

### CROSS-REFERENCE TO RELATED APPLICATION AND CLAIM OF PRIORITY

This application claims priority to and the benefit of Korean Patent Application No. 10-2005-0104202 filed in the Korean Intellectual Property Office on Nov. 2, 2005, the entire content of which is incorporated herein by reference.

### FIELD OF THE INVENTION

The present invention relates to a catalyst for a fuel cell, to a method of preparing the same, and to a membrane-electrode assembly for a fuel cell including the same. More particularly, the present invention relates to a catalyst for a fuel cell having excellent electro-conductivity and catalyst activity, to a method of preparing the same, and to a membrane-electrode assembly for a fuel cell including the same.

### BACKGROUND OF THE INVENTION

A fuel cell is a power generation system for producing electrical energy through an electrochemical redox reaction of an oxidant and fuel such as hydrogen, or a hydrocarbon-based material such as methanol, ethanol, natural gas, and the like. Such a fuel cell is a clean energy source that can replace fossil fuels and includes a stack composed of unit cells that produces various ranges of power output. Since it has a four to ten times higher energy density than a small lithium battery, it has been highlighted as a small portable power source.

Representative exemplary fuel cells include a polymer electrolyte membrane fuel cell (PEMFC) and a direct oxidation fuel cell (DOFC). The direct oxidation fuel cell includes a direct methanol fuel cell that uses methanol as fuel.

The polymer electrolyte membrane fuel cell has an advantage of high energy density and high power, but it also has problems in the need to carefully handle hydrogen gas and the requirement of accessory facilities such as a fuel reformer for reforming methane or methanol, natural gas, and the like in order to produce hydrogen as the fuel gas.

A direct oxidation fuel cell has a lower energy density than other types of fuel cell, but has the advantages of easy handling of the liquid-type fuel, a low operation temperature, and no need for an additional fuel reformer to reform the fuel to generate the hydrogen gas and supplies the hydrogen gas to the stack. Therefore, it has been acknowledged as an appropriate system for a portable power source for small and common electrical equipment.

In the fuel cell system, the stack that generates electricity includes several to several tens of unit cells stacked adjacent to one another, and each unit cell is formed of a membrane-electrode assembly (MEA) and a separator (also referred to as a bipolar plate). The membrane-electrode assembly is composed of an anode (also referred to as a “fuel electrode” or an “oxidation electrode”) and a cathode (also referred to as an “air electrode” or a “reduction electrode”) that are separated by a polymer electrolyte membrane.

Fuel is supplied to an anode and adsorbed on catalysts of the anode, and the fuel is oxidized to produce protons and electrons. The electrons are transferred into a cathode via a circuit, and the protons are also transferred into the cathode through the polymer electrolyte membrane. In addition, an oxidant is supplied to the cathode, and then the oxidant, protons, and electrons are reacted on catalysts of the cathode to produce electricity along with water.

The above information disclosed in this Background section is only for enhancement of understanding of the background of the invention and therefore, it should be understood that the above information may contain information that does not form the prior art that is already known in this country to a person or ordinary skill in the art.

### SUMMARY OF THE INVENTION

One embodiment of the present invention provides a catalyst for a fuel cell having excellent electro-conductivity and catalyst activity.

Another embodiment of the present invention provides a method for manufacturing the catalyst.

Yet another embodiment of the present invention provides a membrane-electrode assembly that includes the catalyst.

According to a first embodiment of the present invention, a catalyst for a fuel cell is provided that includes a platinum (Pt) nanowire and a carbon-based material supporting the Pt nanowire.

According to another embodiment of the present invention, a catalyst for a fuel cell is provided that includes a catalytic material having a nanowire shape and a carbon-based material on which the catalytic material is supported

According to another embodiment of the present invention, a method of manufacturing the cathode catalyst for a fuel cell is provided that includes preparing a support by mixing a carbon-based material having an aspect ratio of more than or equal to 1 and a supporting aid, adding a catalyst metal precursor solution to the support to prepare a catalyst precursor supported on the support, heating the catalyst precursor supported on the support, and treating with acid.

According to another embodiment of the present invention, a membrane-electrode assembly is provided that includes a cathode and an anode facing each other, and an electrolyte interposed therebetween. At least one of the anode and the cathode includes the above catalyst.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 schematically shows the structure of a fuel cell system according to one embodiment of the present invention;

FIGS. 2 to 4 are photographs of a catalyst according to Example 1 taken using a high-resolution transmission electron microscope (HRTEM);

FIG. 5 is a photograph of catalysts according to Example 1 taken using fast Fourier transform (FFT) and then Inverse fast Fourier transform (IFFT); and

FIGS. 6 and 7 shows cell performances of single cells according to Example 2 and Comparative Examples 1 and 2.

### DETAILED DESCRIPTION OF THE INVENTION

Embodiments of the present invention will hereinafter be described in detail with reference to the accompanying drawings.

In general, there are many ways to support platinum on a support. There are some easy methods of preparing a low supported catalyst, to which an incipient wetness process belongs. According to this method, a catalyst metal is supported on a support by calculating pores of the support first, preparing a catalyst metal precursor solution in the same amount as the pores, adding it to the support in a dropwise fashion, and drying it to fill the pores with the catalyst metal precursor solution. This method is simple but the amount of a catalyst metal in a catalyst metal precursor solution should be increased to prepare a highly-supported catalyst because the pores of the carrier are too small compared with the amount of the catalyst metal precursor solution if the low concentration of the catalyst metal precursor solution is used. However, it is difficult to prepare the high concentration of the catalyst metal precursor solution due to a solubility problem. Accordingly, it is impossible to prepare a highly-supported catalyst by this method. Even though a highly-supported catalyst can be partly prepared in this method, a catalyst metal therein is coagulated into large-sized particles, deteriorating catalyst activity.

The present invention improves this incipient wetness process to prepare a catalyst including platinum having a nanowire shape, and, thereby, increases the amount of a catalyst supported on a support and improves activity and electro-conductivity of the catalyst.

According to one embodiment of the present invention, a catalyst for a fuel cell includes platinum (Pt) nanowire, and a carbon-based material supporting the Pt nanowire.

The Pt nanowire has an average diameter of 1.5 to 10 nm, preferably 2 to 4 nm, and a length of 3 nm to 10 μm, and preferably 10 nm to 1 μm. When Pt nanowire has the average diameter and length of 1.5 to 10 nm, it may have not only high usage efficiency to its mass, but also high activity, and maintain good contact with an ionomer. However, when it is out of the above range, it may have low usage efficiency to its mass and low activity, and it is not easy to maintain good contact with the ionomer.

According to the embodiment of the present invention, Pt nanowire may be a linear fiber having a ratio of more than 3, preferably 5 to 10,000, and more preferably 10 to 7,000 of an average length/an average diameter.

The Pt nanowires enter the pores of a carbon-based material, and thereby play a role of promoting the catalyst reaction, increasing an active surface area, and preventing blocking of a binder material.

The Pt nanowire can be supported on a carbon-based material in a ratio of 5 to 90 wt %, preferably 10 to 80 wt %, based on the total weight of the catalyst. When Pt nanowire is included in less than 5 wt %, the catalyst has deteriorated usage efficiency to a carbon-based material, while when Pt nanowire is included in more than 90 wt %, the platinum has deteriorated usage efficiency. When Pt nanowire is supported in a small amount, it is suitable for a polymer electrolyte membrane fuel cell, while when it is supported in an amount of more than 50 wt %, it is suitable for a direct methanol fuel cell.

According to one embodiment of the present invention, a catalyst may include Pt nano-particles as well as the Pt nanowire.

The Pt nano-particles exist between Pt nanowires supported on the carbon-based material and thereby play a role of increasing reaction areas.

The Pt nano-particles have an average particle size of 2 to 8 nm, preferably 2 to 6 nm. When a Pt nano-particle has a size of less than 2 nm it may lose catalyst characteristics, while when the size is more than 8 nm it may have low catalyst usage efficiency.

The Pt nano-particles can be supported on the aforementioned carbon-based material.

According to one embodiment of the present invention, a catalyst may include Pt nanowire and Pt nano-particles in a weight ratio of 10:90 to 90:10. When the Pt nanowire and Pt nano-particles have a weight ratio of less than 10:90, the Pt nanowire does not have a sufficient effect. On the other hand, when the Pt nanowire and Pt nano-particles have a weight ratio of more than 90:10, only the Pt nanowire has an effect. More preferably, the Pt nanowire and the Pt nano-particles may be preferably included in a weight ratio of 20:80 to 60:40. When they are included in this range, the Pt nano-particles are positioned in empty spaces in the carbon-based material and the Pt nanowire by using the high conductivity of the Pt nanowire and particular surface activity of Pt, and thereby, the usage efficiency of the Pt and the carbon-based material is increased, securing excellent performance of a fuel cell.

The Pt nanowire is supported on a carbon-based material.

The carbon-based material plays a role of a support in the catalyst. Preferably, the carbon-based material has an aspect ratio of more than or equal to 1. It may more preferably have an aspect ratio ranging from 1.5 to 100. When the carbon-based material has an aspect ratio of less than 1, the catalyst may be supported on the carbon-based material unstably and may be easily separated from the carbon-based material, and thereby, the amount of the catalyst supported on the carbon-based material may be decreased. When the length of a carbon-based material is considered as a width and the diameter of the carbon-based material as a height, the aspect ratio in the present invention indicates the width divided by the height.

In particular, the carbon-based material has an average diameter of 20 nm to 80 nm and a length of 1 to 5 μm.

The carbon-based material may be a vapor-grown carbon fiber (VGCF), carbon nanotube (CNT), carbon nanohorn, carbon nanoring, carbon nanowire, or carbon nanorod. Preferably, carbon nanotube may be suitable. The carbon-based material has a multi-wall structure in which graphitized crystalline structures are linearly arranged.

According to one embodiment of the present invention, a catalyst for a fuel cell may further include a supporting aid selectively used to increase the supported amount of the catalyst when the catalyst is prepared with the carbon-based material.

The supporting aid plays a role of complementing the insufficient surface area of the carbon-based material, and thereby increases the supported amount of the platinum catalyst and its dispersion rate. It may include at least one compound including an element selected from the group consisting of silicon, zirconium, aluminum, and titanium. It may preferably include at least one selected from the group consisting of silica, fumed silica, zeolite, zirconia, alumina, and titania, and preferably, fumed silica.

The supporting aid may be included in an amount of less than or equal to 5 wt % based on the total weight of a catalyst, and preferably, in an amount of 1 to 3 wt %. When the supporting aid is included in an amount of less than or equal to 5 wt %, it can help oxidation of a humidifying agent and methanol. However, when included in an amount more than 5 wt %, it may deteriorate conductivity of the catalyst layer. According to one embodiment of the present invention, a catalyst for a fuel cell includes a catalytic material having a nanowire shape, and a carbon-based material on which the catalytic material is supported.

Hereinafter, a method of preparing the catalyst for a fuel cell according to an embodiment of the present invention will be described.

An exemplary method of preparing the catalyst for a fuel cell according to an embodiment of the present invention includes preparing a catalyst precursor by mixing a carbon-based material with a catalyst metal precursor solution, and then heat-treating the catalyst precursor.

More particularly, a catalyst precursor of the present invention is prepared by mixing a carbon-based material having an aspect ratio of more than or equal to 1 with a catalyst metal precursor solution.

The carbon-based material may be the same as described above. It can be used without pretreatment or after pretreatment such as acid-treatment, and then washing and heat treatment.

The acid-treatment process during the pretreatment is performed by impregnating a carbon-based material in an acid solution such as nitric acid, sulfuric acid, phosphoric acid, and fluorine acid. Since the acid treatment increases a functional group (—OH, —COOH, and the like) in the carbon-based material, a catalyst can more stably be supported and its dispersion rate increases. In addition, a hydrophobic carbon-based material can be changed into a hydrophilic carbon-based material during the pretreatment process.

Next, it can be washed to remove the acid used during the former treatment, and then additionally heat-treated. Herein, the heat treatment is performed at 400 to 500° C. for 5 to 24 hours under an air atmosphere after the carbon-based material is once or twice washed. The heat-treatment of the pretreatment has an effect of completely removing the small amount of the acid still remaining even after the washing process.

A supporting aid can be used by being mixed with a carbon-based material to increase the supported amount of the catalyst, before the carbon-based material is mixed with the catalyst metal precursor solution.

The supporting aid is the same as described above and can be removed during the additional acid treatment after preparing a catalyst with a heat treatment.

The supporting aid may be included in two to six times, and preferably four to five times, as much as the weight of Pt. When the supporting aid is included in an amount less than the above range, its amount is too small to play a role of being a supporting aid, and also, a catalyst metal can be produced with big particles. When in an amount more than the above range, its amount is too big to be economical.

The supporting aid may be mixed with the carbon-based material in an organic solvent, water, or a mixed solvent thereof, which helps them to be uniformly mixed together. The organic solvent may include n-propylalcohol, isopropylalcohol, methylalcohol, ethylalcohol, or ethylene glycol.

When the carbon-based material and the supporting aid are mixed by using a solvent, the resulting mixture may further be dried, and thereafter ground, obtaining a powdered support. However, when the mixing process does not include a solvent, the resulting mixture only needs to be ground without being dried.

Then, a catalyst precursor is prepared by mixing the prepared carbon-based material or the prepared mixture of a carbon-based material and a supporting aid with a catalyst metal precursor solution.

Examples of the catalyst metal precursor include at least one selected from the group consisting of H₂PtCl₆, PtCl₂, PtBr₂, (NH₃)₂Pt(NO₂)₂, K₂PtCl₆, K₂PtCl₄, K₂[Pt(CN)₄]3H₂O, K₂Pt(NO₂)₄, Na₂PtCl₆, Na₂[Pt(OH)₆], platinum acetylacetonate, ammonium tetrachloroplatinate, and combinations thereof. According to one embodiment, H₂PtCl₆ may preferably be used.

The catalyst metal precursor solution may include water, alcohol such as methanol, ethanol, isopropanol, and the like, or a mixture thereof as a solvent.

The amount of the catalyst metal precursor solution is determined by calculating how much a catalyst is supported in a carbon-based material.

Considering how much the catalyst is supported, the carbon-based material and the catalyst metal precursor are mixed in a weight ratio of 60:40 to 90:10, and preferably, in a weight ratio of 70:30 to 80:20. The mixing ratio of 60:40 to 90:10 makes it possible to regulate the size and shape of the Pt catalyst. However, when the mixing ratio is not within 60:40 to 90:10, the Pt catalyst particles may be too big or a carbon-based material may be inefficiently used.

The catalyst metal precursor solution may be added to a carbon-based material in a dropwise fashion so that it can be uniformly supported on the carbon-based material, obtaining a catalyst precursor.

The obtained catalyst precursor can be additionally dried before the heat treatment. The additional drying process can help the catalyst precursor to be uniformly dispersed. The drying process may include an ultra-sonication method and the like. The catalyst precursor may be ground into a fine powder after the drying process.

Then, the catalyst precursor is heat-treated, preparing a catalyst for a fuel cell.

The heat treatment is performed at not more than 250° C. and preferably, at 150 to 200° C. When the heat treatment is performed at higher than 250° C., a catalyst may have too big Pt particles.

The heat treatment may be performed for 30 minutes to 10 hours and preferably, for 1 to 5 hours. When the heat treatment time is performed for less than 30 minutes, the crystallinity of the Pt is not good, while when performed for more than 10 hours, the Pt particles tend to be too big.

In addition, the heat treatment may be performed under a hydrogen or vacuum atmosphere, and preferably, under a hydrogen atmosphere.

The heat treatment plays a role of reducing the platinum catalyst precursor to prepare the catalyst for a fuel cell.

When a supporting aid is used to prepare the catalyst for a fuel cell, the supporting aid can be further eluted from the reduced product that is obtained from the heat treatment

Accordingly, the supporting aid can be completely or partly removed during the elution process.

The elution process can be performed by using an acid or a base, and controlled by regulating its concentration or mixing time. The acid may include fluorine acid, and the base may include NaOH, KOH, NH₃OH, NH₃CO₃, Na₂CO₃, or the like. When the fluorine acid is used, a 40% HF solution is three times added to its equiavlent quantity, and then agitated for 24 hours to elute a supporting aid. In addition, when NaOH is used, more than 1M of a NaOH solution is added to the reduced platinum catalyst precursor, agitated for 24 hours, and then, filtered to remove the supporting aid.

The elution process can decrease the amount of the supporting aid remaining in the final catalyst to not more than 5 wt %. When the supporting aid remains more than 5 wt %, the remaining supporting aid may deteriorate conductivity of the catalyst layer, and thereby deteriorate performance of a fuel cell.

According to the aforementioned method of the present invention, a catalyst for a fuel cell is prepared by supporting nanowire-shaped Pt on a carbon-based material to increase not only the amount of the supported Pt but also the active surface area of the catalyst, and thereby, has excellent activity. In addition, the Pt nanowire exists connected in the catalyst, and thereby, the catalyst has increased electroconductivity.

The catalyst can have more excellent activity in a direct oxidation fuel cell using a hydrocarbon fuel than in other types of fuel cell. It can have more excellent activity in a direct methanol fuel cell using methanol as fuel; that is to say, a catalyst of the present invention can best work for a direct methanol fuel cell.

In addition, the catalyst for a fuel cell may be used for both a cathode and an anode.

The cathode and the anode in a fuel cell are not distinguished depending on their material, but the electrodes for a fuel cell are distinguished into an anode for oxidizing fuel such as hydrogen, methanol, ethanol, hydrogen carboxyl acid, and the like, and a cathode for reducing oxygen (air). In other words, the anode is supplied with fuel such as hydrogen or a hydrocarbon-based material and the cathode is supplied with oxygen to have an electrochemical reaction and thereby produce electricity. The anode oxidizes a fuel and the cathode reduces oxygen, thereby generating a voltage difference between the two electrodes.

Hereinafter, an exemplary membrane-electrode assembly employing the catalyst according to an embodiment of the present invention and an exemplary fuel cell including the membrane-electrode assembly will be described.

A membrane-electrode assembly for a fuel cell includes an anode and a cathode facing each other, and a polymer electrolyte membrane interposed therebetween. At least one of the anode and the cathode includes a catalyst.

The catalyst included the anode and/or the cathode is the same as described above.

The catalysts of the cathode and the anode are disposed on electrode substrates. The electrode substrates respectively support the anode and the cathode and provide paths for transferring fuel and oxidant to the catalyst layers. As for the electrode substrates, a conductive substrate is used. For example, the conductive substrate may be a carbon paper, a carbon cloth, a carbon felt, or a metal cloth (a porous film including a metal cloth fiber or a metallized polymer fiber), but is not limited thereto.

The electrode substrates may be treated with a fluorine-based resin to be water-repellent to prevent deterioration of diffusion efficiency due to water generated during operation of the fuel cell. The fluorine-based resin may include polyvinylidene fluoride, polytetrafluoroethylene, fluorinated ethylene propylene, polychlorotrifluoroethylene, a fluoroethylene polymer, or copolymers thereof, but is not limited thereto.

A microporous layer (MPL) can be further added between the aforementioned electrode substrates and the catalyst layers to increase reactant diffusion effects. The microporous layer generally includes conductive powders with a particular particle diameter. The conductive material may include, but is not limited to, carbon powder, carbon black, acetylene black, activated carbon, carbon fiber, fullerene, nano-carbon, or combinations thereof. The nano-carbon may include a material such as carbon nanotube, carbon nanofiber, carbon nanowire, carbon nanohorn, carbon nanoring, or combinations thereof. The microporous layer is formed by coating a composition including a conductive powder, a binder resin, and a solvent on the conductive substrate. Non-limiting examples of the binder resin include polytetrafluoroethylene, polyvinylidene fluoride, polyvinyl alcohol, cellulose acetate, and so on. The solvent may include, but is not limited to, an alcohol such as ethanol, isopropyl alcohol, n-propyl alcohol, butanol, and so on, water, dimethyl acetamide, dimethyl sulfoxide, N-methylpyrrolidone, and tetrahydrofuran. The coating method may include, but is not limited to, screen printing, spray coating, doctor blade methods, gravure coating, dip coating, silk screening, and painting, depending on the viscosity of the composition.

The polymer electrolyte membrane functions as an ion exchange, transferring protons generated in an anode catalyst layer to a cathode catalyst layer, and thus, can include any proton-conductive polymer resin that is generally used as a polymer electrolyte membrane of a fuel cell. The proton-conductive polymer resin may be a polymer resin having a cation exchange group selected from the group consisting of a sulfonic acid group, a carboxylic acid group, a phosphoric acid group, a phosphonic acid group, and derivatives thereof, at its side chain.

Non-limiting examples of the polymer resin include at least one proton conductive polymer selected from the group consisting of fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In one embodiment, the proton conductive polymer is at least one selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), or poly (2,5-benzimidazole).

In general, the polymer electrolyte membrane has a thickness ranging from 10 to 200 μm.

A method of fabricating the polymer electrolyte membrane, a hot-pressing method, and processing conditions thereof are well known to this art. Therefore, a detailed description is omitted.

According to an embodiment of the present invention, a fuel system includes the above membrane-electrode assembly.

The fuel cell system of the present invention includes at least one of an electricity generating element, a fuel supplier, and an oxidant supplier. The electricity generating element includes a membrane-electrode assembly and separators disposed at each side of the membrane-electrode assembly. It generates electricity through oxidation of fuel and reduction of an oxidant.

The fuel supplier plays a role of supplying the electricity generating element with fuel including hydrogen and the oxidant supplier plays a role of supplying the electricity generating element with an oxidant such as oxygen or air. The fuel includes liquid or gaseous hydrogen, or a hydrocarbon-based fuel such as methanol, ethanol, propanol, butanol, or natural gas.

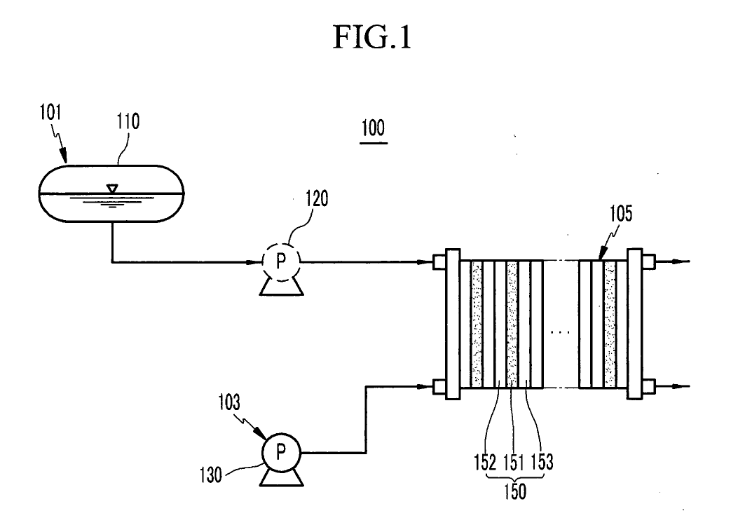

FIG. 1 shows a schematic structure of a fuel cell system that will be described in detail with reference to this accompanying drawing as follows. FIG. 1 illustrates a fuel cell system 100 wherein fuel and an oxidant are provided to an electricity generating element 150 through pumps 120 and 130, but the present invention is not limited to such structure. The fuel cell system of the present invention may alternatively include a structure wherein fuel and an oxidant are provided in a diffusion manner.

The fuel cell system 100 includes a stack 105 including at least one electricity generating element 150 that generates electrical energy through an electrochemical reaction of fuel and an oxidant, a fuel supplier 101 for supplying fuel to the electricity generating element 150, and an oxidant supplier 103 for supplying the oxidant to the electricity generating element 150.

In addition, the fuel supplier 101 is equipped with a tank 110, which stores the fuel, and a pump 120, which is connected therewith. The fuel pump 120 supplies the fuel stored in the tank 110 with a predetermined pumping power.

The oxidant supplier 103, which supplies the electricity generating element 150 of the stack 105 with the oxidant, is equipped with at least one pump 171 for supplying the oxidant with a predetermined pumping power.

The electricity generating element 150 includes a membrane-electrode assembly 151 that oxidizes fuel such as hydrogen or a hydrocarbon-based material and reduces an oxidant, and separators 152 and 153 that are respectively positioned at opposite sides of the membrane-electrode assembly 151 and supply fuel such as hydrogen, or a hydrocarbon-based material and an oxidant.

The following examples illustrate the present invention in more detail. However, it is understood that the present invention is not limited by these examples.

### EXAMPLE 1

5 g of carbon nanotube was put in a 60% nitric acid solution. The mixture was agitated at room temperature for 5 hours, and thereafter, washed with distilled water. Then, it was filtered and heat-treated in a 400° C. muffle furnace for 5 hours to remove nitric acid remaining in the carbon nanotube.

5 parts by weight of the pre-treated carbon nanotube were mixed with 95 parts by weight of fumed silica (the surface area: 380 m2/g, Aldrich Co.). Then, the resulting mixture was mixed with a solvent of n-propylalcohol, isopropylalcohol, and water, which was mixed in a volume ratio of 1:1:1, with a ball mill. The mixture was dried, and thereafter, ground with a grinder to prepare a powder-shaped support.

Next, 20 parts by weight of an H₂PtCl₆ solution was added to 80 parts by weight of the support in a dropwise fashion to prepare a catalyst precursor supported on the support. The catalyst precursor supported on the support was treated with an ultrasound, and then dried. The dried product was ground, and thereafter, heat-treated at 200° C. for 5 hours under a hydrogen atmosphere. Then, it was treated with HF to remove fumed silica used as a supporting aid, preparing a Pt nanowire catalyst for a fuel cell supported on carbon nanotube.

The prepared catalyst included 80 wt % of Pt nanowire and Pt nano-particles based on the entire catalyst weight. The Pt nanowire was included in the catalyst at 30 to 40 wt % more than the Pt nano-particles.

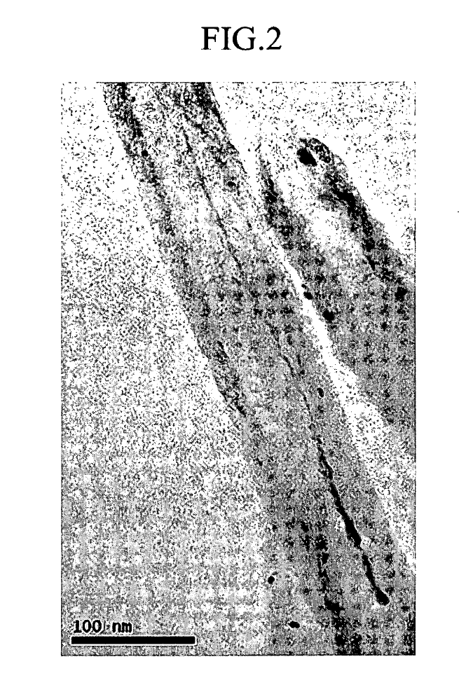

The catalyst for a fuel cell according to Example 1 was observed with a high-resolution transmission electron microscope (HRTEM). The result is provided in FIGS. 2 to 5.

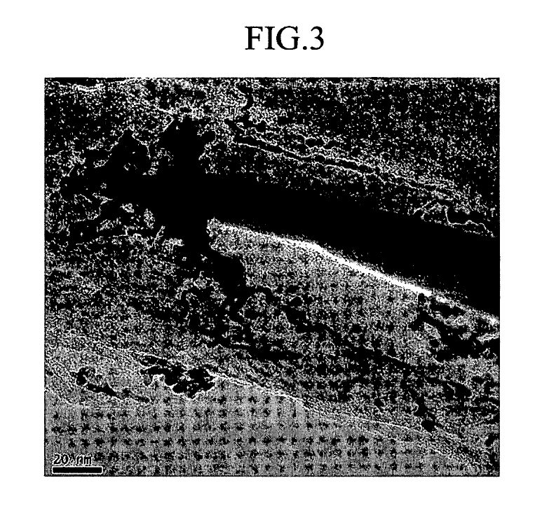

FIGS. 2 and 3 show photographs of the platinum nanowire catalyst prepared according to Example 1, and each scale bar is respectively 100 nm and 20 nm.

As shown in FIGS. 2 and 3, Pt nanowire and Pt nano-particles exist on the surface of the carbon nanotube (CNT).

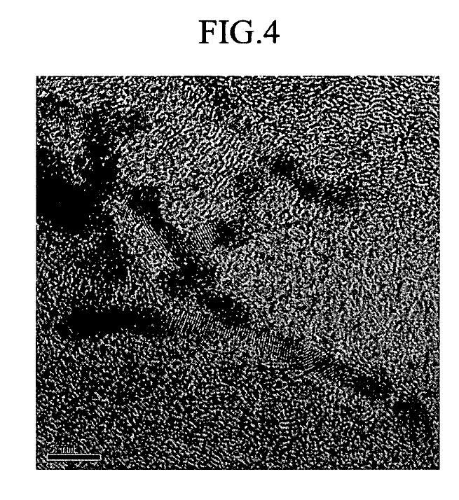

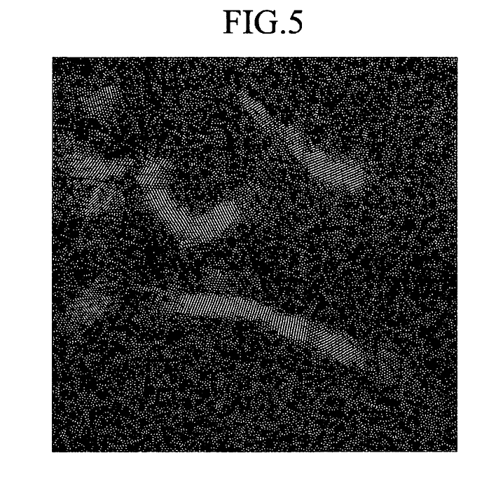

FIG. 4 shows a 500,000 times-enlarged photograph of platinum nanowire prepared according to Example 1, and its scale bar is 5 nm. FIG. 5 is a photograph of the Pt nanowire identified by performing FFT (Fast Fourier Transform) and subsequently IFTT (Inverse Fast Fourier Transform) to analyze the structure of the Pt nanowire in a catalyst of Example 1.

As shown in FIGS. 4 and 5, Pt nanowire has a size ranging 2 to 3 nm and is shaped as one wire, rather than a chain, in which Pt nano-particles are connected to one another. In addition, the Pt nanowire is supported on the surface of the CNT (a carbon-based material), and a Pt lattice indicates that Pt nanowire has single crystallinity.

### EXAMPLE 2

10 parts by weight of a catalyst prepared according to Example 1 was put in a solvent of water and isopropylalcohol mixed in a weight ratio 10:80, and a Nafion solution (Nafion 1100 EW, Dupont Co.) was added thereto. Then the resulting product was uniformly applied with an ultrasound and agitated to prepare a composition for forming a catalyst layer.

The composition for forming a catalyst layer was spray-coated on a carbon paper substrate (cathode/anode=SGL 31BC/10DA; SGL carbon group products) treated with TEFLON (tetrafluoroethylne) to prepare a cathode. An anode was prepared by the same method by using a PtRu black catalyst (HiSPEC 6000, Johnson Matthey Co.). The anode was coated to have a catalyst layer of 6 mg/cm² and the cathode was coated to have a catalyst layer of 4 mg/cm² to prepare the electrodes.

Next, the anode and the cathode were stacked at either side of a commercially-available polymer electrolyte membrane (a catalyst-coated membrane-type Fuel Cell MEA, Dupont Co.; Nafion 115 Membrane) to prepare a membrane-electrode assembly. The prepared membrane-electrode assembly was interposed between gaskets, and thereafter, between two separators having a predetermined gas flow channel and a cooling channel, and then compressed between copper end plates to prepare a single cell.

### Comparative Example 1

A single cell was prepared by the same method as Example 2 except that Pt particles with an average particle size of 4 nm was used as a catalyst.

### Comparative Example 2

A single cell was prepared by the same method as Example 2 with the exception of using Pt particles with an average particle size of 8 nm as a catalyst.

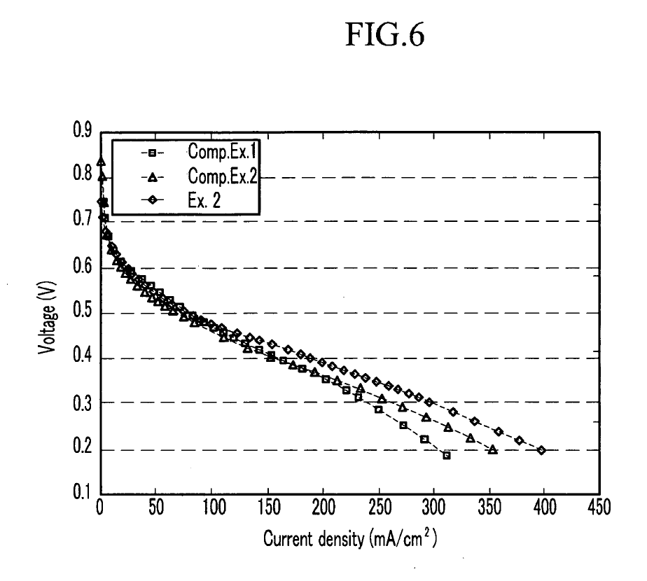

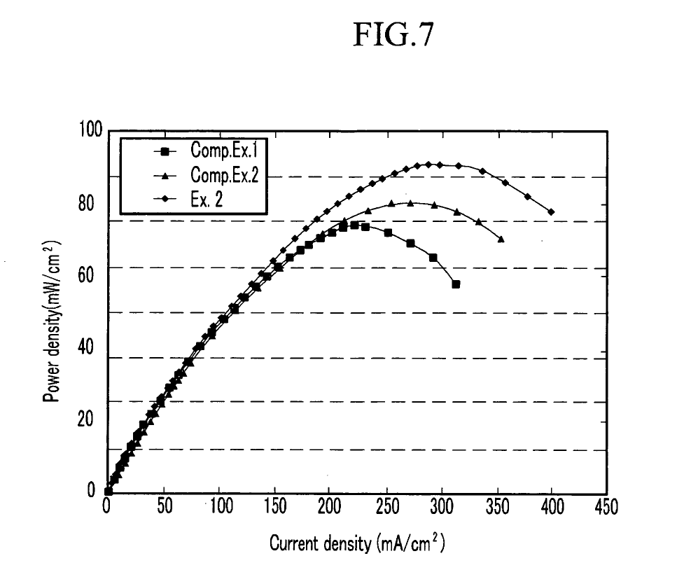

The single cells according to Example 2 and Comparative Examples 1 and 2 were operated under 1M of methanol/air and estimated regarding their performance. The results are provided in FIGS. 6 and 7.

As shown in FIGS. 6 and 7, the fuel cell of Example 2 including a catalyst of the present invention turned out to have higher voltage than those of Comparative Examples 1 and 2 at the same current density, that is to say, had more than 30% increased power output density compared with those of Comparative Examples 1 and 2.

Therefore, the present invention provides a catalyst for a fuel cell having excellent catalyst activity and electro-conductivity by increasing an amount supported on a support and its active surface area, thereby improving performance of the fuel cell.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A catalyst for a fuel cell, comprising:
a platinum (Pt) nanowire; and
a carbon-based material on which the Pt nanowire is supported.

2. The catalyst of claim 1, wherein the Pt nanowire has an average diameter ranging from 1.5 to 10 nm.

3. The catalyst of claim 1, wherein the Pt nanowire has a length ranging from 3 nm to 10 μm.

4. The catalyst of claim 1, wherein the Pt nanowire is supported on the carbon-based material in an amount of 5 to 90 wt % based on the total weight of the catalyst.

5. The catalyst of claim 1, further comprising Pt nano-particles positioned in the Pt nanowire and supported on the carbon-based material.

6. The catalyst of claim 5, wherein the Pt nano-particles have an average particle size ranging from 2 to 8 nm.

7. The catalyst of claim 5, wherein the Pt nanowire and Pt nano-particles are included in a weight ratio of 10:90 to 90:10.

8. The catalyst of claim 1, wherein the carbon-based material has an aspect ratio of more than or equal to 1.

9. The catalyst of claim 1, wherein the carbon-based material is at least one selected from the group consisting of a vapor grown carbon fiber, a carbon nanotube, a carbon nanohorn, a carbon nanoring, a carbon nanowire, a carbon nanorod, and a combination thereof.

10. The catalyst of claim 1, wherein the carbon-based material is carbon nanotube.

11. The catalyst of claim 1, further comprising a supporting aid.

12. The catalyst of claim 11, wherein the supporting aid is a compound including an element selected from the group consisting of silicon, zirconium, aluminum, titanium, and a combination thereof.

13. The catalyst of claim 11, wherein the supporting aid is included in an amount of less than or equal to 5 wt % based on the total weight of the catalyst.

14. A membrane electrode assembly including a catalyst layer having the catalyst of claim 1.

15. A catalyst for a fuel cell, comprising:
a catalytic material having a nanowire shape; and
a carbon-based material on which the catalytic material is supported.

16. A method of manufacturing a catalyst for a fuel cell, comprising:
preparing a a carbon-based material;
adding a catalyst metal precursor solution including a catalyst metal precursor to the carbon-based material to prepare a catalyst precursor; and
heat-treating the catalyst precursor to obtain the catalyst supported on the carbon-based material on which the Pt nanowire is supported.

17. The method of claim 16, wherein the carbon-based material has an aspect ratio of more than or equal to 1.

18. The method of claim 16, wherein the carbon-based material is at least one selected from the group consisting of a vapor grown carbon fiber, a carbon nanotube, a carbon nanohorn, a carbon nanoring, a carbon nanowire, a carbon nanorod, and a combination thereof.

19. The method of claim 16, wherein the preparation of the carbon-based material comprises acid-treating the carbon-based material by using an acid, washing the carbon-based material and heat-treating the carbon-based material to remove the acid.

20. The method of claim 16, wherein the catalyst metal precursor is selected from the group consisting of H₂PtCl₆, PtCl₂, PtBr₂, (NH₃)₂Pt(NO₂)₂, K₂PtCl₆, K₂PtCl₄, K₂[Pt(CN)₄]3H₂O, K₂Pt(NO₂)₄, Na₂PtCl₆, Na₂[Pt(OH)₆], platinum acetylacetonate, ammonium tetrachloroplatinate, and a combination thereof.

21. The method of claim 16, wherein the carbon-based material and the catalyst metal precursor are mixed in a weight ratio of 60:40 to 90:10.

22. The method of claim 16, further comprising mixing the carbon-based material and a supporting aid before the addition of the catalyst metal precursor solution.

23. The method of claim 22, wherein the supporting aid is a compound including an element selected from the group consisting of silicon, zirconium, aluminum, titanium, and a combination thereof.

24. The method of claim 22, wherein the supporting aid is mixed in an amount two to six times as much as the weight of the platinum.

25. The method of claim 22, wherein the supporting aid is mixed with the carbon-based material in an organic solvent, water, or a mixed solvent thereof, and after the mixing, the mixture is dried and powdered.

26. The method of claim 22, further comprising eluting the supporting aid after the heat-treatment to decrease the amount of the supporting aid remaining in the catalyst to less than or equal to 5 wt %.

27. The method of claim 16, wherein the heat-treatment is performed at a temperature of less than or equal to 250° C.

28. The catalyst manufactured by the method of claim 16.

29. A membrane-electrode assembly for a fuel cell comprising:
a cathode and an anode facing each other, at least one of the anode and the cathode comprises a catalyst comprising:
a platinum (Pt) nanowire: and
a carbon-based material supporting the Pt nanowire; and
an electrolyte interposed between the cathode and the anode.
